(19) United States
(12) Patent Application Publication
(10) Pub. No.: US 2025/0197302 A1
(43) Pub. Date: Jun. 19, 2025

(54) DENSE AND SELF-HEALING ZrB2-SiC ANTI-OXIDATIVE MULTILAYER COATINGS FOR CARBON/CARBON COMPOSITES

(71) Applicant: THE UNIVERSITY OF TULSA, Tulsa, OK (US)

(72) Inventors: Jose C. Cordeiro, JR., Curitiba (BR); Hema Ramsurn, Tulsa, OK (US); Michael W. Keller, Tulsa, OK (US)

(21) Appl. No.: 18/914,635

(22) Filed: Oct. 14, 2024

Related U.S. Application Data
(60) Provisional application No. 63/610,511, filed on Dec. 15, 2023.

(51) Int. Cl. C04B 41/50

(52) U.S. Cl. CPC C04B 41/5059; C04B 41/507

(57) ABSTRACT

Disclosed are methods for preparing a carbon/carbon composite having protective layers suitable for precluding oxidative weight loss and self-healing carbon/carbon composites prepared according to the disclosed methods.

### CROSS REFERENCE TO RELATED APPLICATIONS

The present application claims priority to U.S. Provisional Application No. 63/610,511 filed on Dec. 15, 2023, which is incorporated herein.

### STATEMENT REGARDING FEDERALLY SPONSORED RESEARCH OR DEVELOPMENT

This invention was made with government support under contract number DE-EE0008736 awarded by Solar Energy Technologies Office, U.S. Department of Energy. The government has certain rights in the invention.

### BACKGROUND

Carbon/Carbon (C/C) composites are lightweight, highly thermal conductive, with low coefficient of thermal expansion materials that find use in niche applications, such as rocket nozzles, heat shield of space vehicles, and disk brakes of airplanes. Unfortunately, when operating at temperatures greater than 500° C. and under oxidizing conditions, such as in air, C/C composites experience significant mass loss due to oxidation. Ceramic coatings may be used to inhibit oxidation; however, such coatings must be selected for their ability to adhere to the C/C composite and must have a coefficient of thermal expansion similar to the C/C composite. To overcome the problems of currently available methods and the products produced by the same, the present disclosure provides novel methods for applying a protective coating to C/C composites and C/C composites with novel, self-healing, protective coatings.

### SUMMARY OF THE INVENTION

A carbon/carbon composite comprising:
a plurality of layers overlaying the carbon/carbon composite wherein a first layer is a pack cementation layer of silicon carbide in direct contact with the carbon/carbon composite;
a CVD-SiC layer over the pack cementation layer of SiC and filing any pores or cracks in the pack cementation layer of SiC;
a first ZrB₂—SiC layer overlaying the CVD-SiC layer; and,
a top layer of CVD-SiC.

In one embodiment, the methods disclosed herein provide a C/C composite with a self-healing surface having at least three combined or intermingled layers. These three layers include:
a combined or intermingled layer of PC-SiC and CVD-SiC with a thickness which may range from about 20 microns to about 25 microns;
a combined or intermingled layer of ZrB₂—SiC and CVD-SiC with a thickness which may range between about 20 microns to about 25 microns; and,
a top overlay of CVD-SiC having a thickness of about 15 microns to about 20 microns.

In another embodiment, the methods disclosed herein provide a C/C composite with a self-healing surface having at least three combined or intermingled layers. These four layers include:
a combined or intermingled layer of PC-SiC and CVD-SiC with a thickness which may range from about 20 microns to about 25 microns
a combined or intermingled layer of ZrB₂—SiC and CVD-SiC with a thickness which may range between about 20 microns to about 25 microns
a second combined or intermingled layer of ZrB₂—SiC and CVD-SiC with a thickness which may range between about 25 microns and about 30 microns; and,
top overlay of CVD-SiC having a thickness of about 15 microns to about 20 microns.

In one embodiment the current disclosure provides a method for providing an improved C/C composite. The method may be summarized as follows:
1. Provide a C/C composite.
2. Perform pack cementation on the C/C composite to yield a layer of PC-SiC on the C/C composite.
3. Perform CVD using hexamethyldisilane, methyltrichlorosilane or silane gas to provide a CVD-SiC layer on the C/C composite with the PC-SiC layer and within cracks or pores of the PC-SiC layer.
4. Prepare slurry of ZrB₂ powders with a SiC precursor (polycarbosilane, polydimethylsilane or derivatives of polycarbonsilane such as liquid polycarbosilane or mixtures containing polycarbosilane with either xylene or divinyl benzene.) Coat the C/C composite of Step 3 and heat to provide a layer of ZrB₂—SiC which provides self-healing ability.
5. Repeat of Step 3 to provide a CVD-SiC layer over and within cracks/pores of the previous layers.
6. Repeat of Step 4 to provide a second layer of ZrB₂—SiC.
7. Repeat of Step 3.

In another embodiment the current disclosure provides a method for providing an improved C/C composite. The method may be summarized as follows:
1. Provide a C/C composite.
2. Perform pack cementation on the C/C composite to yield a layer of PC-SiC on the C/C composite.
3. Perform CVD using hexamethyldisilane, methyltrichlorosilane or silane gas to provide a CVD-SiC layer on the C/C composite with the PC-SiC layer and within cracks or pores of the PC-SiC layer.
4. Prepare slurry of ZrB₂ powders with a SiC precursor (polycarbosilane, polydimethylsilane or derivatives of polycarbonsilane such as liquid polycarbosilane or mixtures containing polycarbosilane with either xylene or divinyl benzene. Coat the C/C composite of Step 3 and heat to provide a layer of ZrB₂—SiC which provides self-healing ability.
5. Repeat of Step 3 to provide a CVD-SiC layer over and within cracks/pores of the previous layers.

### BRIEF DESCRIPTION OF THE DRAWINGS

FIG. 1 represents the process steps used to apply the ZrB₂—SiC multilayer coating on a C/C composite sample.

FIG. 2 is a detailed schematic representation of each layer of the final coating on a C/C composite sample, depicting the pores which will be filled by CVD-SiC.

FIG. 3 represents a C/C composite after Steps 1-3 of FIG. 1.

FIG. 4 is a C/C composite following application of the protective layers of ZrB₂—SiC layer and CVD silicon carbide.

FIG. 5 is a scanning electron microscope photograph of a cross-section of C/C composite taken along line 5-5 in FIG. 4 following application of the protective layers of silicon carbide and ZrB₂.

FIG. 6 compares results obtained for different coated C/C composite samples prepared according to the disclosed method, all oxidized in air at 850° C.

FIG. 7 represents the aging behavior of C/C composites prepare according to the disclosed method when exposed to the indicated temperature.

FIG. 8 represents the X-ray diffraction analysis of C/C composites samples prepared according to the disclosed method before and after oxidation in air for 150 hours at 850° C.

FIG. 9 is the chemical structure of a silicon carbide suitable for use in the disclosed method.

FIG. 10 is the XRD result of a C/C composite sample coated with PC and slurry coating only, after oxidation in air at 850° C. for 25 hours.

### DETAILED DESCRIPTION

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

The present disclosure may be understood more readily by reference to these detailed descriptions. For simplicity and clarity of illustration, where appropriate, reference numerals may be repeated among the different figures to indicate corresponding or analogous elements. The following description is not to be considered as limiting the scope of the embodiments described herein. The drawings are not necessarily to scale and the proportions of certain parts may have been exaggerated to better illustrate details and features of the present disclosure. Also, the phraseology and terminology employed herein is for the purpose of description and should not be regarded as limiting except where indicated as such.

Throughout this disclosure, the terms “about”, “approximate”, and variations thereof, are used to indicate that a value includes the inherent variation or error for the device, system, or measuring method being employed as recognized by those skilled in the art.

As used herein the term carbon/carbon composite (C/C composite) refers to a composite material prepared from materials such as polyacrylonitrile (PAN) carbon fibers, pitch-based carbon fibers or carbonized fibers, combined with a carbon matrix. The matrix material may be any conventional material commonly used in C/C composites. Matrices commonly include materials such as but not limited to: pitches, polymeric resin, chemical vapor infiltration of the composite material by a hydrocarbon gas, coke, sintered carbon, graphite and other high molecular carbon materials suitable for binding the other carbon materials. The following disclosure provides a method of applying a multilayer coating to C/C composites. As such, the following disclosure does not relate to the formation of the initial C/C composites; rather, the preparation of such materials is well known to those skilled in the art. The resulting multilayer coating protects the C/C (Carbon/Carbon) composite from mass loss during operation in air at temperatures in excess of 500° C.

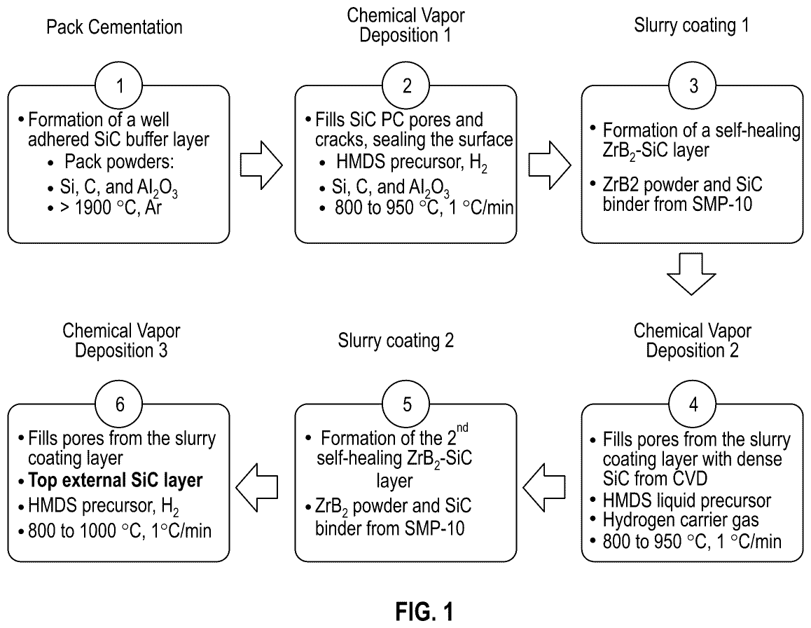

The disclosed multilayer application method provides a C/C composite carrying multiple layers of silicon carbide (SiC). As depicted by the process flow diagram of FIG. 1, the present method utilizes a six-step method which includes separate chemical vapor deposition (CVD) steps. Typically, the method utilizes three separate CVD steps.

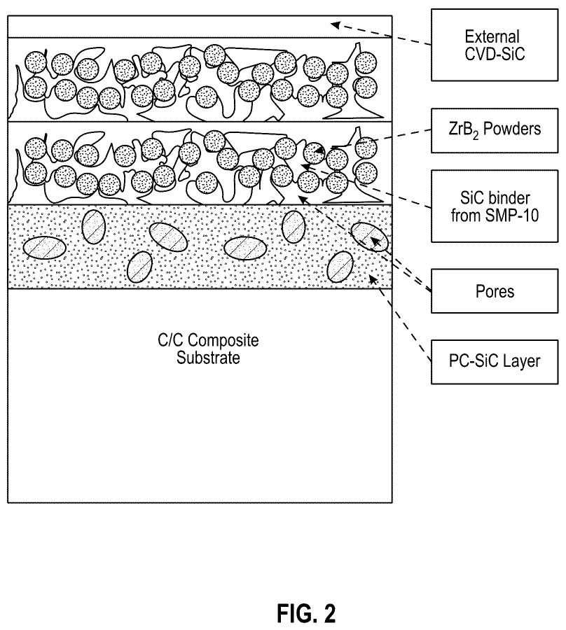

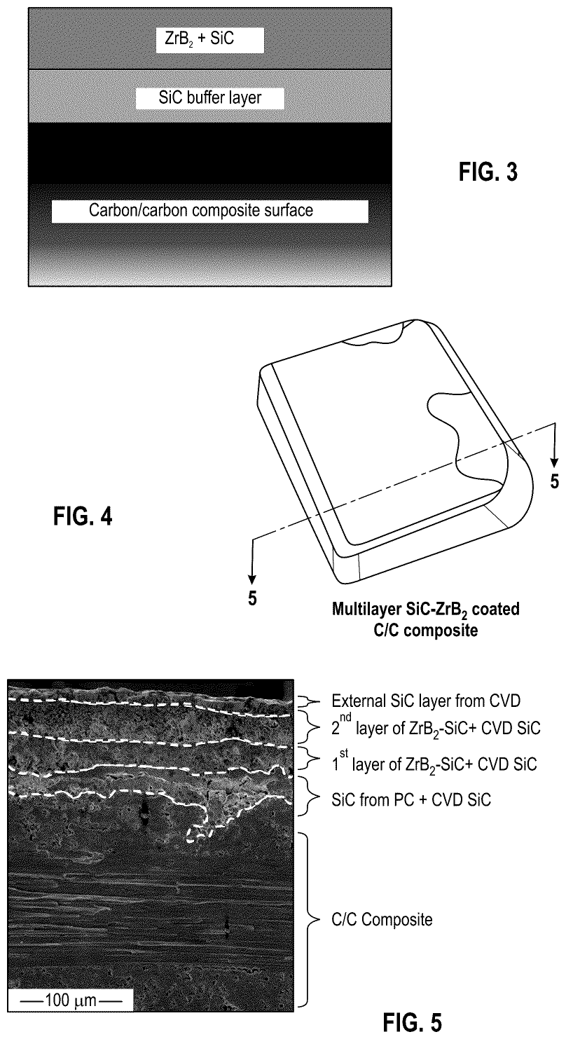

FIGS. 2 and 5 provide representations of the final C/C composite with the resulting protective layers. As reflected in the FIGS., the first CVD-SiC layer is intermingled with the pack cementation layer of SiC. The second CVD-SiC layer is intermingled with the first ZrB₂—SiC layer and the third CVD-SiC layer is intermingled with the second ZrB₂—SiC layer. The resulting carbon/carbon composite has self-healing properties as the layers of ZrB₂—SiC will form oxides when exposed to high temperatures under oxidizing conditions. The resulting oxides, primarily in the form of ZrO₂ and SiO₂ will expand and fill any surface cracks in the carbon/carbon composite resulting from heating stresses.

The initial Step involves the pack cementation (PC) of the C/C composite in a closed container containing a mixture of powders. The powders used are graphite, silicon, silicon carbide and aluminum oxide. The percent by weight for each component is:
graphite from about 5 to about 15% by weight, most commonly about 10% by weight;
silicon from about 50 to about 80% by weight, most commonly about 55% by weight;
silicon carbide from about 0 to about 30% by weight, most commonly about 30% by weight;
aluminum oxide (Al₂O₃) from about 5 to about 10% by weight, most commonly about 5% by weight.
The powders are mixed and milled to provide an average particle size of about 325 mesh or smaller (<44 microns).
   The C/C composite to be coated is placed within the container and covered with the powders, i.e. packed within the powders. While the method above specifies the use of graphite, silicon, silicon carbide and aluminum oxide, substitutions and additions to the powder mix can be made. For example, the graphite can be replaced with any carbon source like vitreous carbon, highly oriented pyrolytic graphite and high density polycrystalline graphite suitable for reacting with the silicon under the pack cementation conditions. Likewise, inert fillers such as, but not limited to, MgO can be added to promote diffusion and powders such as ZrB₂ may be included for their promotion of high oxidation resistance.

A SiC layer is deposited by heating the C/C composite and powders within the closed container to a target temperature between about 1600° C. and about 2000° C. at a rate of about 5° C./minute to about 15° C./minute, under an inert atmosphere. Suitable inert atmospheres include argon and other gases which are non-reactive with the components within the closed container. During this Step, the components in the reactor are held at the target temperature for a period of about 60 minutes to about 180 minutes. Typically, during initial heating, the components are first allowed to dwell at around 1450° C. for a hold time of about 30 minutes. The desired hold time should be sufficient to permit substantially complete melting of the silicon powders. During this Step, SiO_{(g)} evolves from the powders and reacts with the surface carbon of the C/C composite forming a SiC buffer layer on the surface of the C/C composite. The SiC buffer layer on the surface of the C/C composite is also referred to as a pack cementation SiC layer or PC-SiC layer.

In Step 2, a CVD process is used to fill any pores and cracks in the initial pack cementation SiC buffer layer with SiC. The CVD process utilizes a SiC precursor such as liquid HMDS (hexamethyldisilane). The layers of SiC resulting from CVD are referred to as CVD-SiC (chemical vapor deposition-silicon carbide layer). Additional SiC precursors include HMDS, methyltrichlorosilane (MTS) and silane gas which may be deposited at the appropriate deposition temperatures for formation of SiC as known to those skilled in the art.

To initiate the CVD process of Step 2, the C/C composite with the PC layer of SiC is placed in a reactor suitable for carrying out the CVD Steps. Prior to initiating the CVD process, the reactor must be pre-heated to a target temperature of about 750° C. to about 850° C. Typically, the pre-heat step will occur at a rate of about 5° C./min to about 25° C./min with the passage of a first carrier gas through the reactor.

The typical first carrier gas for this process is hydrogen or a mixture of Ar/H₂. The preferred hydrogen will have a purity of about 99.9%. The hydrogen or hydrogen portion of the carrier gas aids in the formation of SiC. Generally, the reactor is pre-heated to about 800° C. at a rate of 20° C./minute. Upon reaching the target temperature, a second carrier gas along with the HMDS precursor is injected or passed into the reactor. For example, the injection may be achieved using a bubbler operating at pressure between about 30 kPa and about 80 kPa with a second hydrogen carrier gas flowing through the bubbler at a rate between about 5 sccm and about 30 sccm. Typically, the HMDS addition with the second carrier gas takes place at a bubbler pressure of about 60 kPa and a hydrogen flow rate through the bubbler of about 20 sccm. In most operations, the first carrier gas flows to the reactor at a rate between about 50 sccm and about 150 sccm. More typically, the flow rate of the first carrier gas will be about 100 sccm. During the CVD process, the pressure within the reactor will typically be between 10 Pa and about 2000 Pa. Typically, the pressure within the reactor will be less than 1000 Pa.

Following initiation of HMDS addition, the reactor is heated to the desired deposition temperature of about 900° C. to about 1000° C. by increasing the temperature of the reactor at a rate between about 0.5° C. and 2° C. per minute. Typically, the target temperature is about 950° C. and the rate of increase in temperature occurs at a rate of about 1° C./minute to provide for deposition of CVD-SiC in any pores and cracks in the initial PC-SiC buffer layer. Thus, the flow of the SiC precursor continues until the resulting CVD-SiC provides a layer which overlays the initial PC-SiC layer and intersects or intermingles with the initial PC-SiC layer. The total thickness of the combined PC-SiC layer and the CVD-SiC layer may range from about 20 microns to about 25 microns.

Following generation of the pack cementation SiC buffer layer and sealing of the PC layer with CVD-SiC on the C/C composite, Step 3 of FIG. 1 provides for the deposition of an initial layer of ZrB₂—SiC over the prior layers on the C/C composite. The deposition of the ZrB₂—SiC layer begins with the preparation of a slurry of ZrB₂ powders with a SiC precursor. One suitable precursor is a polycarbosilane (such as SMP-10), which forms SiC upon pyrolysis. One source of polycarbosilane is SMP-10 from Starfire Systems, Inc. of Glenville, NY. SMP-10 is a liquid at room temperature which produces a silicon to carbon atomic ratio of 1:1. Another source is poly(dimethylsilane) from Gelest, Morrisville, PA as well as derivatives of polycarbosilane (PCS) such as liquid polycarbosilane (LPCS) or mixtures containing polycarbosilane with xylene or divinyl benzene. According to Starfire Systems, Inc., SMP-10 converts to SiC under pyrolysis with a ceramic yield of 72 to 78 percent by weight. To complete the slurry, tetrahydrofuran (THF) is added to the mixture of SMP-10 and ZrB₂ as a solvent. The weight percentage of each component in the resulting slurry is:
ZrB₂ between about 60 and about 80 percent by weight;
SMP-10 between about 5 and about 20 percent by weight;
THF between about 5 and about 35 percent by weight.
   In the examples discussed herein, the weight percentages were: ZrB₂ 71%, SMP-10 16% and THF 13%.

In Step 3, the resulting slurry is applied by any convenient method to the C/C composite already coated with the PC SiC layer and the CVD-SiC layer provided by Steps 1 and 2. For example, the slurry may be applied by spin coating, brushing, controlled dip coating, or even directly dipping of the C/C composite into the slurry. The C/C composite with the applied slurry is allowed to “rest” at room temperature for a period of time sufficient enough to allow the THF solvent to dry or evaporate. Typically, this time period is about 15 minutes to about 60 minutes.

Following drying, the C/C composite with the slurry coating is placed into a suitable reactor, e.g. a quartz tube and heated. Heating in an inert atmosphere, such as an argon (Ar) atmosphere, takes the C/C composite with the slurry coating from room temperature to about 600° at a rate of about 1° C./min. During this heating step, the C/C composite is held at each of the following temperatures for about 1 hour each: about 100° C., about 300° C., and about 600° C. Following these heating steps, the C/C composite is then heated to about 1000° C. at a rate of about 2° C./min, with a hold time at the final temperature of about 2 hours. The resulting layer (Step 3 in FIG. 1) of ZrB₂—SiC provides self-healing ability to the coating through the formation of oxides (mainly ZrO₂ and SiO₂) when exposed to air at high temperatures. Cracks formed at these high temperatures will be self-sealed as these oxides will expand and fill the resulting empty spaces formed by surface cracking.

Following the application of the ZrB₂—SiC layer, Step 4 provides for the addition of another CVD-SiC layer to the C/C composite. Step 4 repeats the same method as those described above in Step 2. The resulting layer of CVD-SiC fills any pores or cracks present in the as deposited slurry layer of ZrB₂—SiC. The total thickness of the combined first ZrB₂—SiC layer and second CVD-SiC layer may range between about 20 microns to about 25 microns.

Step 5 provides a second layer of ZrB₂—SiC on the C/C composite. Step 5 repeats the same steps as described above in Step 3. Finally, Step 6 provides an external or top layer of CVD-SiC. The method for applying the top layer of CVD-SiC corresponds to the process described in Step 2 except with regard to the target temperature. In Step 6, the typical target temperature is about 1000° C. The hold time at the target temperature should be sufficient to provide deposition of the desired external layer of CVD-SiC. Typically, the hold time will be between about 30 minutes to about 120 minutes. More typically, the hold time at the target temperature is about 60 minutes. The resulting combined layer of ZrB₂—SiC layer and CVD-SiC will have a thickness between about 25 microns and about 30 microns with an additional overlay of CVD-SiC having a thickness of about 15 microns to about 20 microns.

Sample C/C composites were prepared according to the foregoing methods. In Step 1, the pack cementation utilized a mixture of powders containing graphite (C, 10 wt %), silicon (Si, 55 wt %), silicon carbide (SiC, 30 wt %), and aluminum oxide (Al₂O₃, 5 wt %) prepared by grinding for 2 hours using ball milling. The C/C samples to be coated were embedded in the pack powders using a graphite crucible closed with a graphite lid. The crucible assembly was then heat treated under atmospheric argon by first heating at 10° C./min to 1450° C., with a dwell time of 30 minutes to allow the silicon to melt, followed by a ramp to 1900° C. at 10° C./min with a hold time of 2 hours to form the PC-SiC layer. During this process, SiO_{(g)} evolved from the powders and reacted with the carbon from the surface of the C/C composite, forming the SiC buffer layer.

Steps 2 and 4 were carried out by preparing a slurry by mixing ZrB₂ powders with SMP-10 (a SiC polymeric precursor) acting as a binder, and THE as a solvent. Upon pyrolysis (under atmospheric argon), SMP-10 converts into SiC with a ceramic yield of 72-78 wt % according to the manufacturer. The proportions for each component of the slurry were optimized to obtain the best coating integrity. During experimentation, observation of the samples indicated that an excessive amount of polycarbosilane, the pre-ceramic precursor (SMP-10), can cause mud-cracking due to the shrinkage of the SiC precursor upon pyrolysis. On the other hand, not enough SMP-10 causes the coating to be powder-like due to the lack of binder. The amount of THF solvent is also important, where too much solvent causes the slurry to be unstable and the powder decants, while not enough solvent will produce a slurry with clumps of ZrB₂ powders. The best proportion of ZrB₂:SMP-10:THF was found to be about 71:16:13 wt %. This ratio will be adjusted in response to additives to the slurry such as but not limited to other phenolic resins, graphite powders and other oxidation resistant ceramics like Al₂O₃, ZrO₂, and Y₂O₃. The C/C composite specimens are then dipped in the slurry, and placed in a quartz crucible, and heated in a quartz tube furnace using the program described in Table 1.

TABLE 1

| | | Rate | Dwell |
|---|---|---|---|
| T₁(° C.) | T₂ (° C.) | (° C./min) | (h) |
| 25 | 100 | 1 | 1 |
| 100 | 300 | 1 | 1 |
| 300 | 600 | 1 | 1 |
| 600 | 1000 | 2 | 1 |

Steps 2 and 4, CVD steps, were carried out using liquid HMDS as the CVD precursor. Samples were heated in a quartz crucible, placed inside a quartz tube furnace. High purity hydrogen was used as the carrier gas at 100 sccm under an absolute pressure of <10 mbar. The system was first heated to 800° C. at 20° C./min with flow of carrier gas only (no precursor). After reaching 800° C., deposition was initiated by opening the precursor line. HMDS liquid precursor was injected using a bubbler kept at 600 mbar, and through which H₂ was flowed at a rate of 20 sccm. The system was then heated to the final deposition temperature (either 950 or 1000° C., depending on the coating step) at a rate of 1° C./min. The slow heating to the final deposition temperature allows SiC to be first deposited in the pores and cracks of the previous PC-SiC (step 2 in FIG. 1) and/or slurry ZrB₂—SiC (steps 4 and 6 in FIG. 1) layers, increasing the overall coating density. The CVD temperature in Steps 2 and 4 was 950° C. with no hold time. In Step 6, the CVD temperature was increased to 1000° C. with a hold time of 1 hour. The longer hold time used in the last CVD step allows the growth of an external CVD-SiC layer. FIGS. 4 and 5 provide images of the C/C composite produced by the foregoing example. FIG. 5 shows the cross-section of the final C/C composite taken by slicing the C/C composite at line 5-5 of FIG. 4.

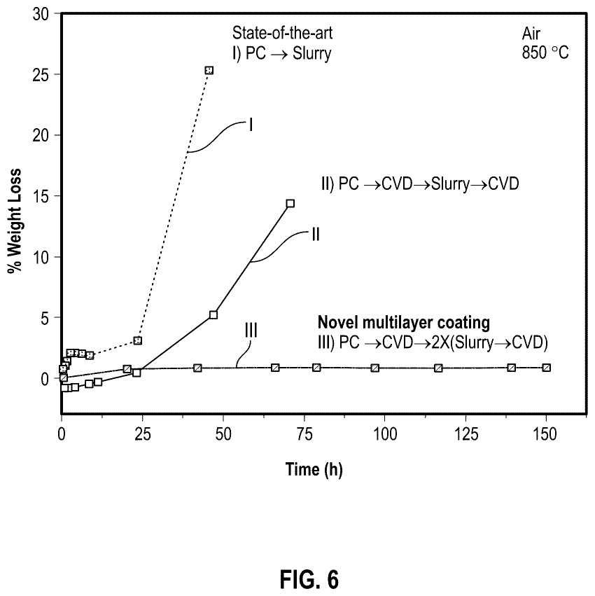

FIG. 6 compares the weight loss of the coated sample prepared in the above example to samples prepared by methods lacking the key steps of the present invention. In FIG. 6, Sample I reflects testing on a material prepared with a pack cementation step using SiC followed by slurry coating with ZrB₂—SiC but lacking the CVD steps. Sample II reflects testing on a material prepared with a pack cementation step using SiC followed by CVD, a single slurry coating of ZrB₂—SiC and a final CVD step. Sample III reflects material prepared according to the process described above, i.e. the product of the inventive method. As reflected in FIG. 6, C/C composites prepared according to the disclosed method experience minimal weight loss even after 150 hours of exposure to air at 850° C. In this test, Sample III experienced no more than 1% weight loss due to oxidation. In contrast, Sample I experience greater than 25% weight loss due to oxidation in about 38 hours and Sample II experienced a weight loss of less than about 15% in about 65 hours.

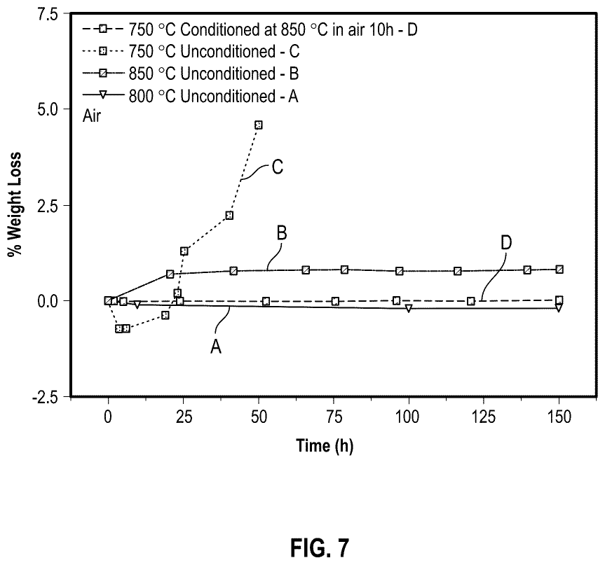

The ability of ZrB₂ to form oxides (mainly ZrO₂ and SiO₂) improves the oxidative protection of the coating at temperatures below 800° C. To achieve the self-healing nature of the final C/C composites with the described layers, samples were first heat treated in air at 850° C. for 10 hours to “condition” the coating, which allows oxides (mainly ZrO₂ and SiO₂) to form and fill any eventual cracks that were formed. FIG. 7 demonstrates oxidation, at different temperatures, of C/C composite samples with the novel multilayer ZrB₂—SiC coating applied as disclosed above. The multilayer ZrB₂—SiC coating developed in this work also proved to be effective in protecting unconditioned C/C composites from oxidation not only at 850° C. (line B) but also at a lower temperature of 800° C. (line A) in air, as shown in FIG. 7, with no significant weight change after 150 hours. However, as reflected by the graph, when oxidizing unconditioned samples at lower temperatures, cracks in the coating allows air to react with the substrate underneath, and thus a weight loss is observed (line C for sample 750° C. unconditioned in FIG. 7). In contrast, FIG. 7, line D demonstrates the benefits provided by conditioning the sample. For line D, a conditioned sample was placed in a muffle furnace at 750° C. for oxidation testing. The conditioned sample was able to withstand exposure to air at 750° C. with no weight loss even after 150 hours.

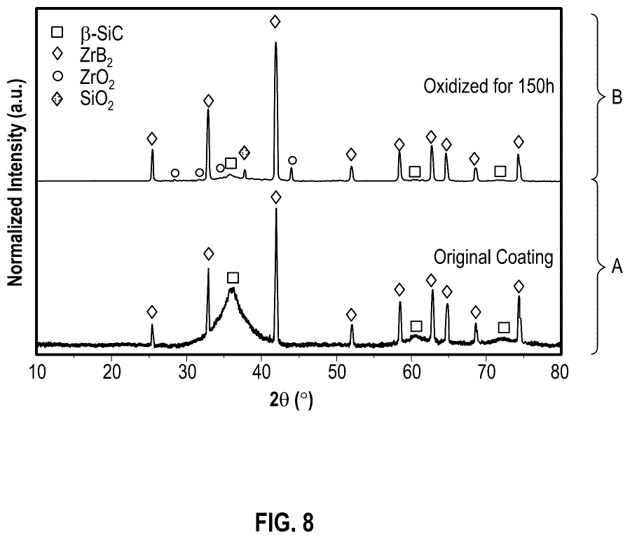

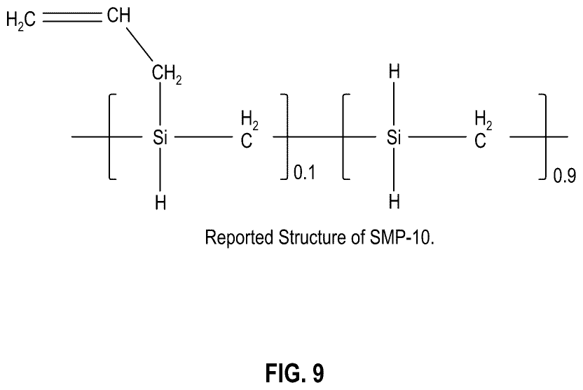

FIG. 8 provides the X-ray diffraction (XRD) results for a C/C composite prepared according to the disclosed method, i.e. the samples carry multiple layers of ZrB₂—SiC. In FIG. 8, the lower portion of the graph, identified as A, reflects the XRD of the C/C composite prior to oxidation at 850° C. for 150 hours. Before oxidation, only the β-SiC (from CVD) and ZrB₂ phases are present. Since XRD analysis occurs only at the surface of the coating, the α-SiC phase from the first layer (PC-SiC) does not appear. The upper portion of the graph (identified as B) reflect the XRD of the C/C composite after oxidation at 850° C. for 150 hours. Following the oxidation step, the oxide phases for the self-healing layers of ZrB₂ appear as ZrO₂ and SiO₂. The resulting oxidation of these layers prohibits loss of carbon from the C/C composite thereby preserving the integrity of the composite. Thus, the resulting composites are considered to be self-healing. This self-healing characteristic provides a composite with better structural integrity under operational conditions in an oxidizing environment.

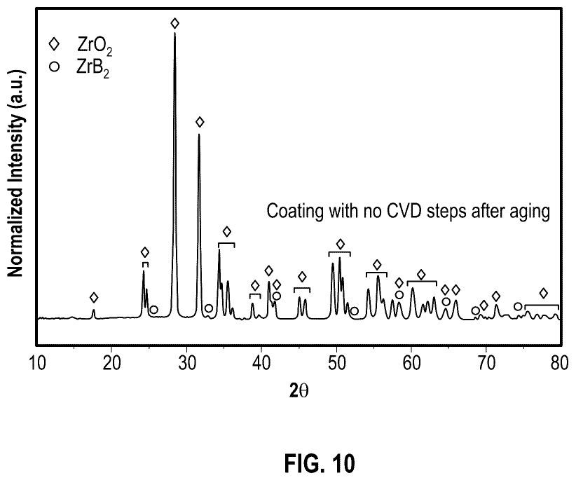

For comparison purposes, a sample was prepared using only the PC and slurry steps. The resulting sample carrying an oxidized coating was examined using XRD analysis. As depicted in FIG. 10 the resulting formation of ZrO₂ is clear with only traces of ZrB₂ detected. Thus, as expected, most of the coating at the surface was oxidized. The results depicted in FIG. 10 further demonstrate that the multilayer ZrB₂—SiC described above prevents excessive formation of ZrO₂ as shown in FIG. 8. Additionally, the results of FIG. 10 explain the failure of samples coated only with PC and slurry coating as reported in FIG. 6, line I as the developed cracks are not able to self-heal fast enough to prevent oxidation.

While the foregoing method was describe as having the six steps described above, modification of this method will also produce improved C/C composites. The six steps described in detail above may be summarized as follows:
1. Perform pack cementation on a C/C composite to yield a layer of PC-SiC on the C/C composite.
2. Perform CVD using hexamethyldisilane, methyltrichlorosilane or silane gas to provide a CVD-SiC layer on the C/C composite with the PC-SiC layer and within cracks or pores of the PC-SiC layer.
3. Prepare slurry of ZrB₂ powders with a SiC precursor (polycarbosilane, polydimethylsilane or derivatives of polycarbonsilane such as liquid polycarbosilane or mixtures containing polycarbosilane with either xylene or divinyl benzene). Coat the C/C composite of Step 2 and heat to provide a layer of ZrB₂—SiC which provides self-healing ability.
4. Repeat of Step 2 to provide a CVD-SiC layer over and within cracks/pores of the previous layers.
5. Repeat of Step 3 to provide a second layer of ZrB₂—SiC.
6. Repeat of Step 2 using a higher target temperature.

While the above steps will provide an exceptional C/C composite having a self-healing surface structure and improved structural integrity, Steps 4 and 5 can be omitted and still provide a C/C composite having a self-healing surface structure. Thus, in one embodiment, the foregoing method provides a C/C composite with a self-healing surface having at least three combined or intermingled layers. These three layers include:
a combined or intermingled layer of PC-SiC and CVD-SiC with a thickness which may range from about 20 microns to about 25 microns;
a combined or intermingled layer of ZrB₂—SiC and CVD-SiC with a thickness which may range between about 20 microns to about 25 microns; and,
a top overlay of CVD-SiC having a thickness of about 15 microns to about 20 microns.
   In another, more typical embodiment, the foregoing method includes all six steps and provides a C/C composite with a self-healing surface having at least four combined or intermingled layers. These four layers include:
a combined or intermingled layer of PC-SiC and CVD-SiC with a thickness which may range from about 20 microns to about 25 microns
a combined or intermingled layer of ZrB₂—SiC and CVD-SiC with a thickness which may range between about 20 microns to about 25 microns
a second combined or intermingled layer of ZrB₂—SiC and CVD-SiC with a thickness which may range between about 25 microns and about 30 microns; and,
top overlay of CVD-SiC having a thickness of about 15 microns to about 20 microns.

Other embodiments of the present invention will be apparent to one skilled in the art. As such, the foregoing description merely enables and describes the general uses and methods of the present invention. Accordingly, the following claims define the true scope of the present invention.

We claim:

1. A carbon/carbon composite comprising:
a plurality of layers overlaying the carbon/carbon composite wherein a first layer is a pack cementation layer of silicon carbide in direct contact with the carbon/carbon composite;
a first chemical vapor deposition-silicon carbide layer over the pack cementation layer of silicon carbide, at least a portion of the first chemical vapor deposition-silicon carbide layer intermingling with the pack cementation layer of silicon carbide;
a first ZrB₂-silicon carbide layer overlaying the chemical vapor deposition-silicon carbide layer;
a second chemical vapor deposition-silicon carbide layer, at least a portion of the second chemical vapor deposition-silicon carbide intermingles with the first ZrB₂-silicon carbide layer to provide a first combined ZrB₂-silicon carbide and chemical vapor deposition-silicon carbide layer;
a second ZrB₂-silicon carbide layer overlaying the chemical vapor deposition-silicon carbide layer;
a third chemical vapor deposition-silicon carbide layer, a portion of the third chemical vapor deposition-silicon carbide intermingles with the second ZrB₂-silicon carbide layer forming a second combined ZrB₂-silicon carbide and chemical vapor deposition-silicon carbide layer wherein a portion of the third chemical vapor deposition-silicon carbide layer is a top layer of chemical vapor deposition-silicon carbide layer.

2. The carbon/carbon composite of claim 1, wherein the first chemical vapor deposition-silicon carbide layer fills any pores or cracks found in the pack cementation layer of silicon carbide.

3. The carbon/carbon composite of claim 1, wherein the second chemical vapor deposition-silicon carbide layer fills any pores or cracks found in the first ZrB₂-silicon carbide layer thereby providing the first combined ZrB₂-silicon carbide and chemical vapor deposition-silicon carbide layer.

4. The carbon/carbon composite of claim 1, wherein the third chemical vapor deposition-silicon carbide layer fills any pores or cracks found in the second ZrB₂-silicon carbide layer thereby providing the second combined ZrB₂-silicon carbide layer and chemical vapor deposition-silicon carbide layer.

5. The carbon/carbon composite of claim 1, wherein the composite does not experience weight loss when placed in an oxidizing environment at a temperature of 750° C.

6. The carbon/carbon composite of claim 1, wherein the composite experiences a weight loss when placed in an oxidizing environment at a temperature of 850° C. for 65 hours of less than 15%.

7. The carbon/carbon composite of claim 1, wherein at least one ZrB₂-silicon carbide layer converts to ZrO₂ and SiO₂ when heat treated in air at 850° C. for 10 hours, thereby providing a carbon/carbon composite having a self-healing layer.

8. The carbon/carbon composite of claim 1, wherein the combined pack cementation silicon carbide layer and first chemical vapor deposition-silicon carbide layer has a thickness between about 20 microns and about 25 microns, the first combined ZrB₂-silicon carbide layer and chemical vapor deposition-silicon carbide layer has a thickness of about 20 microns to about 25 microns, the second combined ZrB₂-silicon carbide layer and chemical vapor deposition-silicon carbide layer has a thickness of about 20 microns to about 25 microns and the top layer of chemical vapor deposition-silicon carbide layer has a thickness of about 15 microns to about 20 microns.

9. A carbon/carbon composite comprising:
a plurality of layers overlaying the carbon/carbon composite wherein a first layer is combined pack cementation layer of silicon carbide in direct contact with the carbon/carbon composite and a first chemical vapor deposition-silicon carbide layer intermingled with the pack cementation layer of silicon carbide
a first combined ZrB₂-silicon carbide and chemical vapor deposition-silicon carbide layer;
a second combined ZrB₂-silicon carbide and chemical vapor deposition-silicon carbide layer overlaying the first combined ZrB₂-silicon carbide and chemical vapor deposition-silicon carbide layer;
a top layer of chemical vapor deposition-silicon carbide layer.

10. The carbon/carbon composite of claim 9, wherein the composite does not experience weight loss when placed in an oxidizing environment at a temperature of 750° C.

11. The carbon/carbon composite of claim 9, wherein the composite experiences a weight loss when placed in an oxidizing environment at a temperature of 850° C. for 65 hours of less than 15%.

12. The carbon/carbon composite of claim 9, wherein a portion of at least one combined ZrB₂-silicon carbide and chemical vapor deposition-silicon carbide layer converts to ZrO₂ and SiO₂ when heat treated in air at 850° C. for 10 hours, thereby providing a carbon/carbon composite having a self-healing layer.

13. The carbon/carbon composite of claim 9, wherein the combined pack cementation silicon carbide layer and first chemical vapor deposition-silicon carbide layer has a thickness between about 20 microns and about 25 microns, the first combined ZrB₂-silicon carbide layer and chemical vapor deposition-silicon carbide layer has a thickness of about 20 microns to about 25 microns, the second combined ZrB₂-silicon carbide layer and chemical vapor deposition-silicon carbide layer has a thickness of about 20 microns to about 25 microns and the top layer of chemical vapor deposition-silicon carbide layer has a thickness of about 15 microns to about 20 microns.

14. A carbon/carbon composite comprising:
a plurality of layers overlaying the carbon/carbon composite wherein a first layer is a pack cementation layer of silicon carbide in direct contact with the carbon/carbon composite;
a first chemical vapor deposition-silicon carbide layer over the pack cementation layer of silicon carbide, at least a portion of the first chemical vapor deposition-silicon carbide layer intermingling with the pack cementation layer of silicon carbide;
a first ZrB₂-silicon carbide layer overlaying the chemical vapor deposition-silicon carbide layer; and,
a second chemical vapor deposition-silicon carbide layer, a portion of the second chemical vapor deposition-silicon carbide intermingles with the first ZrB₂-silicon carbide layer forming a combined ZrB₂-silicon carbide layer and a portion of the second chemical vapor deposition-silicon carbide layer forms a top layer of chemical vapor deposition-silicon carbide layer.

15. The carbon/carbon composite of claim 14, wherein the composite does not experience weight loss when placed in an oxidizing environment at a temperature of 750° C.

16. The carbon/carbon composite of claim 14, wherein the composite experiences a weight loss when placed in an oxidizing environment at a temperature of 850° C. for 65 hours of less than 15%.

17. The carbon/carbon composite of claim 14, wherein a portion of the ZrB₂-silicon carbide and chemical vapor deposition-silicon carbide layer converts to ZrO₂ and SiO₂ when heat treated in air at 850° C. for 10 hours, thereby providing a carbon/carbon composite having a self-healing layer.

18. A method of preparing a carbon/carbon composition having a plurality of layers comprising:
providing a carbon/carbon composite;
applying a pack cementation layer of silicon carbide;
applying a first CVD-silicon carbide layer over the pack cementation layer of silicon carbide;
applying a first ZrB₂-silicon carbide layer over the first CVD-silicon carbide layer;
applying a second layer of CVD-silicon carbide over the first ZrB₂-silicon carbide layer such that the second layer of CVD-silicon carbide fills any cracks or pores in the first ZrB₂-silicon carbide layer.

19. The method of claim 18, wherein the step of applying a pack cementation layer of silicon carbide comprises the steps of:
providing a mixture of powders, the powders including: a silicon powder, silicon carbide, aluminum oxide and a carbon source suitable for reacting with the silicon;
placing a carbon/carbon composite within the mixture of powders and packing the powders around the carbon/carbon composite such that all surfaces of the carbon/carbon composite are covered by the powders;
heating the carbon/carbon composite and the mixture of powders under an inert atmosphere to a final temperature of between about 1600° C. and about 2000° C. at a rate of about 5° C./minute to about 15° C./minute and holding the carbon/carbon composite and the mixture of powders at the final temperature for about 60 minutes to about 180 minutes.

20. The method of claim 18, wherein the step of applying the first CVD-silicon carbide layer over the pack cementation layer of silicon carbide comprises the steps of:
preheating a reactor to a temperature of about 750° C. to about 850° C.;
placing the carbon/carbon composite with the pack cementation layer of silicon carbide in the preheated reactor;
passing a first carrier gas through the preheated reactor;
passing a second carrier gas into the preheated reactor, the second carrier gas is hydrogen;
passing a silicon carbide precursor with the second carrier gas into the preheated reactor;
further heating the reactor to a temperature of about 900° C. to about 1000° C. to produce a CVD-silicon carbide layer which overlays and intermingles with the pack cementation layer of silicon carbide.

21. The method of claim 20, wherein the silicon carbide precursor is selected from the group consisting of: hexamethyldisilane, methyltrichlorosilane and silane.

22. The method of claim 20, wherein the silicon carbide precursor is passed into the preheated reactor at a rate between about 50 sccm and about 150 sccm.

23. The method of claim 20, wherein when the reactor is heated to a temperature of about 900° C. to about 1000° C., the increase occurs at a rate between about 0.5° C. per minute and 2° C. per minute.

24. The method of claim 18, wherein the step of applying the first ZrB₂-silicon carbide layer comprises the steps of:
preparation of a slurry of ZrB₂ powders with a silicon carbide precursor in tetrahydrofuran;
applying the slurry over the CVD-silicon carbide layer;
allowing the slurry to dry;
placing the carbon/carbon composite with the dried slurry in a reactor;
heating the carbon/carbon composite with the dried slurry within the reactor in an inert atmosphere from room temperature to about 600° C.

25. The method of claim 24, wherein the step of heating the carbon/carbon composite to a temperature of about 600° C. pauses the heating process at 100° C. for about one hour, at 200° C. for about one hour, at 300° C. for about one hour and at 600° C. for about one hour, then continues the heating step to a temperature of about 1000° C. and holds the temperature at 1000° C. for about two hours to provide a ZrB₂—SiC layer.

26. The method of claim 18, wherein the step of applying the second layer of CVD-silicon carbide over the first ZrB₂-silicon carbide layer comprises the steps of:
preheating a reactor to a temperature of about 750° C. to about 850° C.;
placing the carbon/carbon composite with the pack cementation layer of silicon carbide, the CVD-silicon carbide layer and the first ZrB₂-silicon carbide layer in the preheated reactor;
passing a first carrier gas through the preheated reactor;
passing a second carrier gas into the preheated reactor, the second carrier gas is hydrogen;
passing a silicon carbide precursor with the second carrier gas into the preheated reactor;
further heating the reactor to a temperature of about 900° C. to about 1000° C. to produce a CVD-silicon carbide layer which overlays and intermingles with the first ZrB₂-silicon carbide layer.

27. The method of claim 18, further comprising the steps of:
applying a second ZrB₂-silicon carbide layer over the second CVD-silicon carbide layer; and,
applying a third layer of CVD-silicon carbide over the first ZrB₂-silicon carbide layer such that the third layer of CVD-silicon carbide fills any cracks or pores in the second ZrB₂-silicon carbide layer.

28. A method of preparing a carbon/carbon composition having a plurality of layers comprising:
providing a carbon/carbon composite;
applying a pack cementation layer of silicon carbide;
applying a first CVD-silicon carbide layer over the pack cementation layer of silicon carbide;
applying a first ZrB₂-silicon carbide layer over the first CVD-silicon carbide layer;
applying a second CVD-silicon carbide layer over the first ZrB₂-silicon carbide layer such that the CVD-silicon carbide layer fills any pores or cracks in the first ZrB₂-silicon carbide layer;
applying a second ZrB₂-silicon carbide layer over the second CVD-silicon carbide layer;
applying a top layer of CVD-silicon carbide over the second ZrB₂-silicon carbide layer such that the top layer of CVD-silicon carbide fills any cracks or pores in the second ZrB₂-silicon carbide layer.

29. The method of claim 28, wherein the step of applying a pack cementation layer of silicon carbide comprises the steps of:
providing a mixture of powders, the powders including: a silicon powder, silicon carbide, aluminum oxide and a carbon source suitable for reacting with the silicon;
placing a carbon/carbon composite within the mixture of powders and packing the powders around the carbon/carbon composite such that all surfaces of the carbon/carbon composite are covered by the powders;
heating the carbon/carbon composite and the mixture of powders under an inert atmosphere to a final temperature of between about 1600° C. and about 2000° C. at a rate of about 5° C./minute to about 15° C./minute and holding the carbon/carbon composite and the mixture of powders at the final temperature for about 60 minutes to about 180 minutes.

30. The method of claim 28, wherein the step of applying the first CVD-silicon carbide layer over the pack cementation layer of silicon carbide comprises the steps of:
preheating a reactor to a temperature of about 750° C. to about 850° C.;
placing the carbon/carbon composite with the pack cementation layer of silicon carbide in the preheated reactor;
passing a first carrier gas through the preheated reactor;
passing a second carrier gas into the preheated reactor, the second carrier gas is hydrogen;
passing a silicon carbide precursor with the second carrier gas into the preheated reactor;
further heating the reactor to a temperature of about 900° C. to about 1000° C. to produce a CVD-silicon carbide layer which overlays and intermingles with the pack cementation layer of silicon carbide.

31. The method of claim 30, wherein the silicon carbide precursor is selected from the group consisting of: hexamethyldisilane, methyltrichlorosilane and silane.

32. The method of claim 30, wherein the silicon carbide precursor is passed into the preheated reactor at a rate between about 50 sccm and about 150 sccm.

33. The method of claim 30, wherein when the reactor is heated to a temperature of about 900° C. to about 1000° C., the increase occurs at a rate between about 0.5° C. per minute and 2° C. per minute.

34. The method of claim 28, wherein the step of applying the first ZrB₂-silicon carbide layer comprises the steps of:
preparation of a slurry of ZrB₂ powders with a silicon carbide precursor in tetrahydrofuran;
applying the slurry over the CVD-silicon carbide layer;
allowing the slurry to dry;
placing the carbon/carbon composite with the dried slurry in a reactor;
heating the carbon/carbon composite with the dried slurry within the reactor in an inert atmosphere from room temperature to about 600° C.

35. The method of claim 34, wherein the step of heating the carbon/carbon composite to a temperature of about 600° C. pauses the heating process at 100° C. for about one hour, at 200° C. for about one hour, at 300° C. for about one hour and at 600° C. for about one hour, then continues the heating step to a temperature of about 1000° C. and holds the temperature at 1000° C. for about two hours to provide a ZrB₂—SiC layer.

36. The method of claim 28, wherein the step of applying the second layer of CVD-silicon carbide over the first ZrB₂-silicon carbide layer comprises the steps of:
preheating a reactor to a temperature of about 750° C. to about 850° C.;
placing the carbon/carbon composite with the pack cementation layer of silicon carbide, the CVD-silicon carbide layer and the first ZrB₂-silicon carbide layer in the preheated reactor;
passing a first carrier gas through the preheated reactor;
passing a second carrier gas into the preheated reactor, the second carrier gas is hydrogen;
passing a silicon carbide precursor with the second carrier gas into the preheated reactor;
further heating the reactor to a temperature of about 900° C. to about 1000° C. to produce a CVD-silicon carbide layer which overlays and intermingles with the first ZrB₂-silicon carbide layer.

37. The method of claim 28, wherein the average particle size of the powders is about 325 mesh or smaller.
